(19) United States
(12) Patent Application Publication
(10) Pub. No.: US 2016/0140585 A1
(43) Pub. Date: May 19, 2016

(54) SYSTEM AND METHOD FOR MANAGING EXTRA CALENDAR PERIODS IN RETAIL

(71) Applicant: ORACLE INTERNATIONAL CORPORATION, Redwood Shores, CA (US)

(72) Inventors: Catalin POPESCU, Atlanta, GA (US); Ming LEI, Lutherville-Timonium, MD (US); Lin HE, Johns Creek, GA (US)

(21) Appl. No.: 14/595,342

(22) Filed: Jan. 13, 2015

Related U.S. Application Data
(60) Provisional application No. 62/080,508, filed on Nov. 17, 2014.

(51) Int. Cl. G06Q 30/02

(52) U.S. Cl. CPC G06Q 30/0202

(57) ABSTRACT

Systems, methods, and other embodiments for providing management of retail forecasts associated with a computer application are described. In one embodiment, historical demand data associated with a retail item sold at a retail location is read from an input data structure associated with the computer application. A determination is made as to when and where an extra retail period occurs in a forecast time domain. Forecasted demand data is generated for retail periods of the forecast time domain, except the extra retail period, based on the historical demand data. Forecasted demand data is generated for the extra retail period based on a portion of the forecasted demand data for the retail periods of the forecast time domain. An output data structure is transformed by populating the output data structure with the forecasted demand data for the retail periods, including the extra retail period, of the forecast time domain.

### CROSS REFERENCE TO RELATED APPLICATIONS

This disclosure claims the benefit of U.S. Provisional Patent Application Ser. No. “62/080,508” filed Nov. 17, 2014, titled “System and Method for Managing Extra Calendar Weeks in Retail”, inventors: Popescu, et al., and assigned to the present assignee.

### BACKGROUND

Forecasting demand (e.g., sales and related inventory) is a big part of managing a retail business. Retailers often manage their businesses using a retail calendar (e.g., 364 days organized into 13-week quarters) that periodically includes an extra week (a 53^{rd} week) such that year end stays at about the same time of the year. The occasional (e.g., every 5 or 6 years) 53^{rd} week accounts for the fact that there are usually 365 days in a year. Furthermore, the 53^{rd} week accounts for the effects of leap years which compensate for the fact that the rotation of the earth does not exactly correspond to 365 days per year. In effect, the 53^{rd} week puts the retail calendar in synchronization with respect to making seasonal comparisons.

Retailers desire to have some control over how this 53^{rd} week is managed within a forecasting system's time dimension. The current approach in the retail industry is to manually perform corrections to properly account for the 53^{rd} week. This can be a time consuming endeavor for retailers when forecasts for many items and stores are to be generated, thus limiting retailers to making the simplest and most-straightforward of corrections. In many cases, the number of retail items and stores is so large that the task can only be accomplished by involving both business users and the IT department, disrupting the normal workflow.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with a retail demand forecasting tool;

FIG. 2 illustrates one embodiment of a method, performed by the retail demand forecasting tool of the computer system of FIG. 1, for forecasting retail demand while accounting for an extra retail period;

FIG. 3 illustrates one embodiment of a portion of the method of FIG. 2, performed by the retail demand forecasting tool of the computer system of FIG. 1, for forecasting retail demand for an extra retail period in the future;

FIG. 4 illustrates first example embodiments of techniques for forecasting retail demand for an extra retail period in the future, as performed by the retail demand forecasting tool of the computer system of FIG. 1, implementing the method of FIG. 3;

FIG. 5 illustrates second example embodiments of techniques for forecasting retail demand for an extra retail period in the future, as performed by the retail demand forecasting tool of the computer system of FIG. 1, implementing the method of FIG. 3; and

FIG. 6 illustrates one example embodiment of a computing device upon which a retail demand forecasting tool of a computing system may be implemented.

### DETAILED DESCRIPTION

The following terms are used herein with respect to various embodiments.

The term “retail calendar”, as used herein, refers to a calendar that is used by retailers which is organized into accounting periods (e.g., quarters) for a retail year which can be made to correspond to the same periods for subsequent years, providing an invaluable forecast tool for management. For example, a retail calendar year may have 52 retail periods where each retail period corresponds to a 7-day week. A retail calendar may be in electronic form as part of a retail calendar computer application, for example.

The term “retail period”, as used herein, refers to a unit increment of time (e.g., a 7-day week) which retailers use to correlate seasonal retail periods from one year to the next in a retail calendar for the purposes of planning and forecasting. The terms “retail period” and “calendar period” may be used interchangeably herein.

The term “extra retail period”, as used herein, refers to an extra unit increment of time (e.g., a 53^{rd} week) that is occasionally inserted into a retail calendar to account for seasonal adjustments from year to year.

The term “retail location”, as used herein, may refer to a physical store where a retail item is sold, or an on-line store via which a retail item is sold.

The term “forecast time domain” or “forecast horizon”, as used herein, refers to a group of future retail periods in a retail calendar for which a forecast of demand (e.g., sales) for a retail item at a retail location is to be made or has been made.

The term “forecasted demand data”, as used herein, refers to data representing predicted demand (e.g., sales) for the future retail periods of a forecast time domain.

The term “historical time domain”, as used herein, refers to a group of past retail periods in a retail calendar for which historical demand (e.g., sales) for a retail item at a retail location have been recorded.

The term “historical demand data”, as used herein, refers to data representing actual demand (e.g., actual sales) for past retail periods of a historical time domain.

Systems, methods, and other embodiments for providing management of retail forecasts associated with a computer application are disclosed. Example embodiments are discussed herein with respect to computerized retail demand forecasting, where a retail calendar may include an extra week (e.g., a 53^{rd} week) in a 52 week year. The extra week serves to keep year end at about the same time of the year. In one embodiment, a retail demand forecasting (RDF) tool is disclosed that is configured to automatically handle the extra 53^{rd} week such that demand forecasts are more accurate. Managing demand for the extra week, both past and future, is the challenge being addressed. In one embodiment, a method is implemented by a computer application to execute on a computing device, wherein the computer application is configured to process a retail calendar in electronic form.

In one embodiment, the retailer provides information with respect to the extra week, and the system “knows” how to handle the demand, such that the forecast is accurate. For example, if the extra week is in the future, the system automatically creates demand for that week, by using and preserving the 52 week seasonal demand pattern. In general, if the system is fed a metric (e.g., flag data) signaling an extra calendar week, the system “knows” how to either create demand for that week, or how to handle it such that it does not adversely affect the future forecast.

The computerized forecasting process discussed herein improves performance and allows for more sophisticated forecasting techniques to be employed. Such an approach automatically handles the extra week, potentially in a sophisticated manner, across multiple retail items (e.g., products) and retail locations (e.g., stores). Furthermore, the approach also impacts usability, since a user doesn't have to attempt to manually perform tedious demand forecasting and can concentrate on core duties.

In accordance with one embodiment, there are two cases to consider. The first case is when one or more years, each with 52 weeks, of historical sales are available, and the retailer desires to forecast for the following year, which has 53 weeks. Thus the time period with 53 weeks has a different amount of weeks compared to the other time periods, which have 52 weeks each. The second case is when one of the years of historical sales has 53 weeks, and the others have 52 weeks. Note that at any given time (depending on the time domain of the historical data and the forecast period) the 53^{rd} week can occur in the future, in the past, or not at all. It is assumed herein that the 53^{rd} week cannot happen in both the past and the future at the same time for a particular forecasting effort.

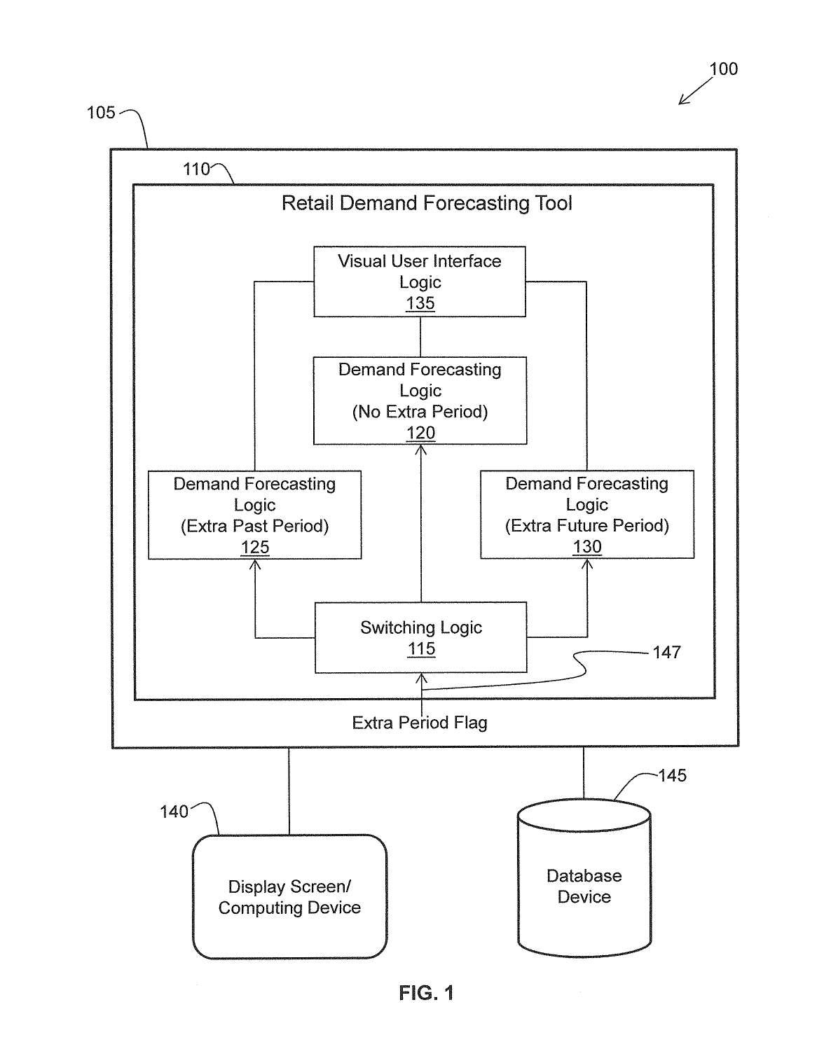

FIG. 1 illustrates one embodiment of a computer system 100, having a computing device 105 configured with a retail demand forecasting (RDF) tool 110. For example, in one embodiment, the RDF tool 110 may be part of a retail calendar computer application of a retail company, configured to forecast and manage demand (e.g., sales) for retail items and various retail locations. In accordance with one embodiment, a graphical user interface is generated by the retail calendar computer application (e.g., by a visual user interface logic of the RDF tool 110).

In one embodiment, the retail calendar computer application may comprise demand forecasting and management software that computerizes the process for forecasting demand for retail items, taking into account the seasonal peculiarities of a retail calendar including any extra retail periods (e.g., a 53^{rd} week). In one embodiment, the software and computing device 105 may be configured to operate with or be implemented as a cloud-based networking system, a software-as-a-service (SaaS) architecture, or other type of computing solution.

With reference to FIG. 1, in one embodiment, the RDF tool 110 is implemented on the computing device 105 and includes logics for implementing various functional aspects of the RDF tool 110. In one embodiment, the RDF tool 110 includes a switching logic 115. Also, in FIG. 1, the RDF tool 110 includes demand forecasting logic (DFL), illustrated as having at least three components or program modules: demand forecasting logic (for no extra period) 120, demand forecasting logic (for extra past period) 125, and demand forecasting logic (for extra future period) 130. Furthermore, the RDF tool 110 includes visual user interface logic 135, in accordance with one embodiment. The various logics illustrated in FIG. 1 are operably connected to each other within the RDF tool 110.

However, other embodiments may provide different logics or combinations of logics that provide the same or similar functionality as the RDF tool 110 of FIG. 1. In one embodiment, the RDF tool 110 is an executable application including algorithms and/or program modules configured to perform the functions of the logics. The application is stored in a non-transitory medium.

The computer system 100 also includes a display screen 140 operably connected to the computing device 105. In accordance with one embodiment, the display screen 140 is implemented to display views of and facilitate user interaction with a graphical user interface (GUI) generated by the visual user interface logic 135 for viewing and updating demand associated with retail calendars. The graphical user interface may be associated with a retail calendar computer application and the visual user interface logic 135 may be configured to generate the graphical user interface. In one embodiment, the RDF tool 110 is a centralized server-side application that is accessed by many users. Thus the display screen 140 may represent multiple computing devices/terminals that allow users to access and receive services from the RDF tool 110 via networked computer communications.

In one embodiment, the computer system 100 further includes at least one database device 145 operably connected to the computing device 105 or a network interface to access the database device 145 via a network connection. In accordance with one embodiment, the database device 145 is configured to store and manage data structures (e.g., records of historical demand data and forecasted demand data) associated with the RDF tool 110 in a database system (e.g., a retail calendar computer application). The RDF tool 110 is also configured to access and read data from an inventory database (not shown) that maintains data records that identify the retail items previously or currently being offered for sale (or will be offered) by the organization. In one embodiment, the inventory database is accessed via network communications.

Referring back to the logics of the RDF tool 110 of FIG. 1, in one embodiment, the visual user interface logic 135 is configured to generate a graphical user interface to facilitate user interaction with the RDF tool 110. For example, the visual user interface logic 130 includes program code that generates and causes the graphical user interface to be displayed based on an implemented graphical design of the interface. In response to user actions and selections via the GUI, associated aspects of demand for retail items may be manipulated.

For example, the visual user interface logic 135 is configured to facilitate inputting of historical demand data, associated with a retail item sold at a retail location, into at least one input data structure associated with a retail calendar computer application via the graphical user interface. Historical demand data includes, for example, one or two years of sales data for a particular item sold at a particular location. The historical demand data may be segmented into retail periods of past weeks, with each past week having a numerical value assigned to it to indicate the number of items sold for that week, in accordance with one embodiment.

Furthermore, the visual user interface logic 135 is configured to facilitate the inputting of flag data (or a data flag) into an input data structure associated with a retail calendar computer application. The flag data (or data flag) indicates when and where an extra retail period occurs in a historical time domain or a forecast time domain associated with a retail item. Also, the visual user interface logic 135 is configured to facilitate the outputting and displaying of forecasted demand data, via the graphical user interface, on the display screen 140. In one embodiment, demand forecasting logic is configured to operably interact with the visual user interface logic 135 to facilitate displaying of forecasted demand data of an output data structure.

Forecasted demand data includes, for example, one year of predicted or forecasted sales data for the particular retail item at the particular retail location. The forecasted demand data may be segmented into retail periods of future weeks, with each future week having a numerical value assigned to it to indicate the number of items predicted to be sold for that week, in accordance with one embodiment. The number of future retail periods (e.g., future weeks) in the forecasted demand data covers the forecast time domain. However, a forecast time domain, having multiple future retail periods, may be defined before generating any forecasted demand data for the forecast time domain.

In one embodiment, the switching logic 115 is configured to trigger a first, a second, or a third forecasting module (120, 125, or 130) of the demand forecasting logic (DFL) in response to flag data associated with an extra retail period flag 147. The flag data indicates to the RDF tool 110 the nature of the historical demand data and the forecast time domain for a retail item at a retail location with respect to any extra retail period (e.g., a 53^{rd} week) that may be present. That is, the flag data tells the RDF tool 110 when an extra retail period is present and where it is present (e.g., an extra 53^{rd} week is present in the forecast time domain between weeks 15 and 17; or, an extra 53^{rd} week is present in the historical demand data between weeks 32 and 34).

When the flag data of the extra period flag 147 indicates that no extra retail period occurs or exists in either the historical demand data or the forecast time domain, then the switching logic 115 triggers the first forecasting module (i.e., demand forecasting logic (no extra period) 120) to execute. In one embodiment, the DFL (no extra period) 120 is configured to generate forecasted demand data for a forecast time domain based on the input historical demand data. There is no extra retail period (e.g., a 53^{rd} week) to take into account.

For example, in accordance with one embodiment, forecasted demand data for a particular future retail period (e.g., week 23) in the forecast time domain is generated by the DFL (no extra period) 120 by considering the historical demand data associated with the same retail periods (e.g., week 23) for the past two years. The DFL (no extra period) 120 may, for example, generate forecasted demand data for the particular future retail period (e.g., week 23) by averaging the historical demand data for the same corresponding retail periods for the past two years. For example, if the historical demand data for week 23 for the past two years is 5 items sold and 3 items sold, respectively, the DFL (no extra period) 120 may generate forecasted demand data of 4 items expected to be sold for week 23 of next year (the forecast time domain).

Alternatively, the DFL (no extra period) 120 may generate forecasted demand data for the particular future retail period (e.g., week 23) by replicating the maximum or minimum value of the historical demand data for the same corresponding retail periods for the past two years. For example, if the historical demand data for week 23 for the past two years is 6 items sold and 5 items sold, respectively, the DFL (no extra period) 120 may generate forecasted demand data of 6 items expected to be sold for week 23 of next year (the forecast time domain).

Other, more sophisticated, techniques of generating forecasted demand data from historical demand data when there is no extra retail period to be accounted for may be implemented as well, in accordance with other embodiments. For example, some techniques may take into consideration multiple retail periods in the vicinity of a retail period under consideration. Such techniques may employ weighted averaging methods to the historical demand data, for example.

Other techniques that may be employed may be considered to be one-sided techniques or two-sided techniques, where the historical demand data being considered is on one side, the other side, or both sides of the retail period under consideration. However, regardless of the specific techniques employed, the DFL (no extra period) 120 is configured to operate on historical time domains and forecast time domains having the same number of retail periods (no extra retail periods present). In this manner, seasonal relationships, patterns, and alignment of retail periods between retail calendar years is readily maintained for the purpose of demand forecasting.

When the flag data of the extra period flag 147 indicates that an extra retail period occurs or exists in the historical demand data, then the switching logic 115 triggers the second forecasting module (i.e., demand forecasting logic (extra past period) 125) to execute. In one embodiment, the DFL (extra past period) 125 is configured to eliminate a portion of the historical demand data, corresponding to the extra retail period, to form modified historical demand data. For example, the demand forecasting logic (extra past period) 125 may be configured to transform an input data structure of historical demand data by eliminating the extra retail period from the input data structure to form the modified historical demand data.

For example, if the historical demand data for last year includes 53 weeks, and the extra retail period (53^{rd} week) occurs between weeks 44 and 46, then the demand data for that extra week occurring between weeks 44 and 46 is eliminated from the historical demand data by the DFL (extra past period) 125. Then, in accordance with one embodiment, the DFL (extra past period) 125 is configured to generate forecasted demand data for a forecast time domain based on the modified historical demand data. The extra retail period (e.g., a 53^{rd} week) in the historical demand data has been taken into account through elimination. In this manner, seasonal relationships, patterns, and alignment of retail periods between retail calendar years is readily maintained for the purpose of demand forecasting.

Once the extra retail period is eliminated from the historical demand data, the DFL (extra past period) 125 may proceed to generate the forecasted demand data for the retail periods of the forecast time domain in a similar manner to that of the DFL logic (no extra period) 120 as described previously herein. For example, replication techniques, averaging techniques, weighted averaging techniques, maximum/minimum techniques, one-sided techniques, and two-sided techniques may be applied to the modified historical demand data.

When the flag data of the extra period flag 147 indicates that an extra retail period occurs or exists in the forecast time domain, then the switching logic 115 triggers the third forecasting module (i.e., demand forecasting logic (extra future period) 130) to execute. In one embodiment, the DFL (extra future period) 130 is configured to generate forecasted demand data, for a retail item at a retail location, over retail periods of the forecast time domain (except the extra retail period) based on the historical demand data. The DFL (extra future period) 130 is also configured to generate forecasted demand data, for the retail item at the retail location, for the extra retail period based on at least a portion of the forecasted demand data for the retail periods of the forecast time domain.

The forecasted demand data is generated for the extra retail period based indirectly on the historical demand data. That is, the DFL (extra future period) 130 generates the forecasted demand data for the other retail periods in the forecast time domain first, based on the historical demand data, then generates the forecasted demand data for the extra retail period based on those other retail periods in the forecast time domain. In this manner, the extra retail period (e.g. a 53^{rd} week) in the forecast time domain is accounted for by the DFL (extra future period) 130.

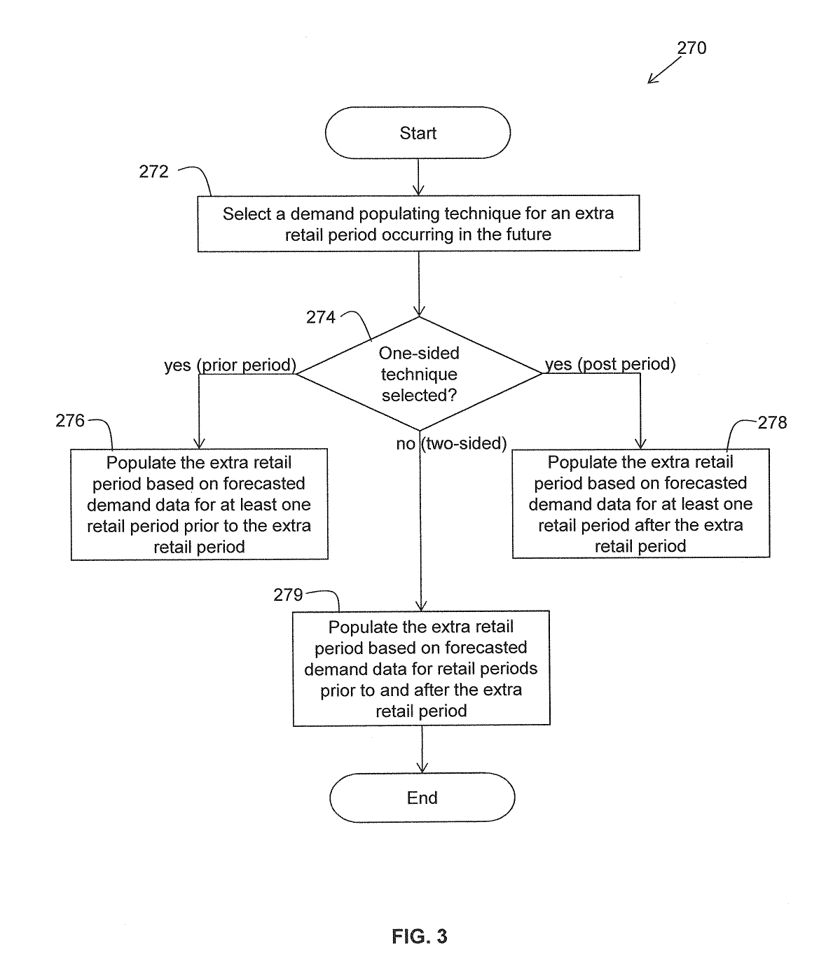

In one embodiment, the DFL (extra future period) 130 is configured to generate the forecasted demand data for the retail periods of the forecast time domain (except the extra retail period) in a similar manner to that of the DFL logic (no extra period) 120 as described previously herein. For example, replication techniques, averaging techniques, weighted averaging techniques, maximum/minimum techniques, one-sided techniques, and two-sided techniques may be applied to the modified historical demand data. Detail examples of how the DFL (extra future period) 130 generates the forecasted demand data for the extra retail period are provided below herein with respect to FIGS. 3-5.

In accordance with one embodiment, each module (120, 125, 130) of the demand forecasting logic of the retail demand forecasting tool 110 is configured to transform an output data structure. The output data structure may be associated with a retail calendar computer application and may be transformed by populating the output data structure with the forecasted demand data for the forecast time domain.

In this manner, a retail demand forecasting tool 110 (e.g., implemented as part of a retail calendar computer application) can accurately forecast retail demand for a particular item to be sold at a particular location, while accounting for any extra retail period in either the historical time domain or the forecast time domain. Similarly, the retail demand forecasting tool 110 can accurately forecast retail demand for a plurality of items to be sold at a plurality of locations, while accounting for any extra retail period in either the historical time domain or the forecast time domain for each item. Large numbers of individual items to be sold at large numbers of individual retail locations may be treated individually by the tool 110 in a sophisticated manner, without sacrificing forecast accuracy and without employing large amounts of time and resources.

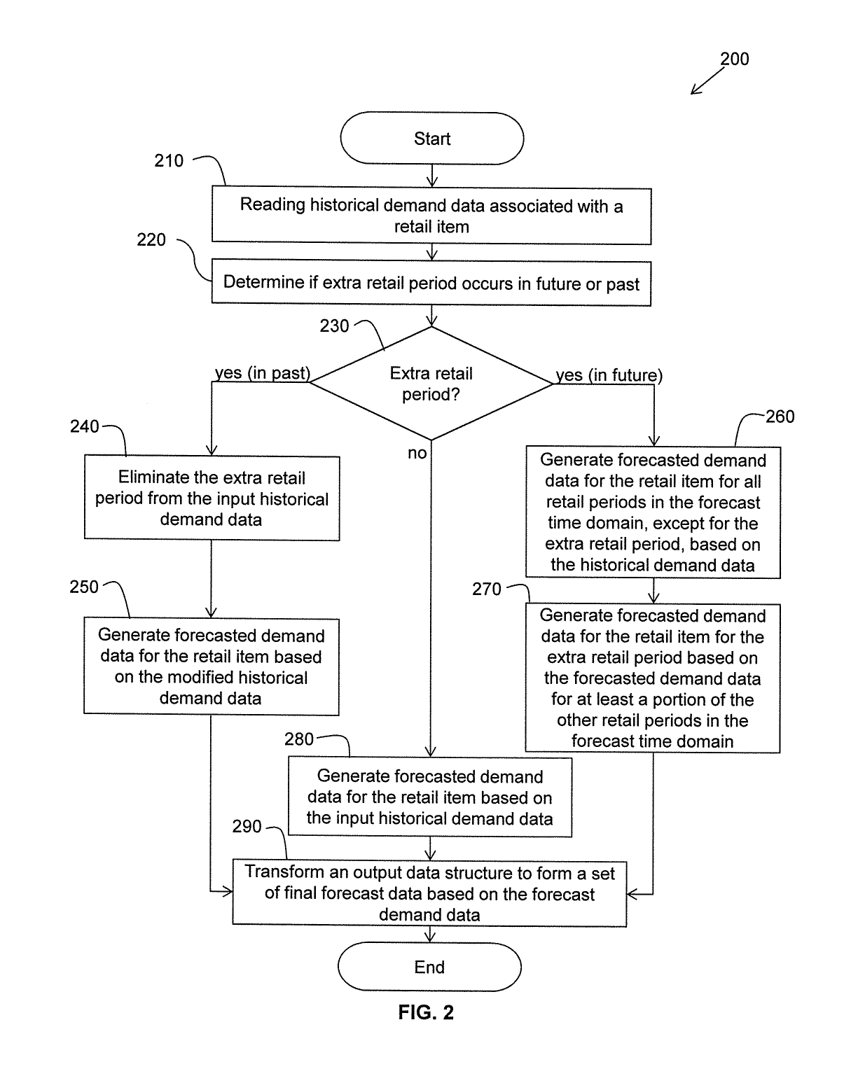

FIG. 2 illustrates one embodiment of a computer-implemented method 200, performed by the retail demand forecasting tool 110 of the computer system 100 of FIG. 1, for forecasting retail demand while accounting for an extra retail period, if present. Method 200 summarizes the operation of switching logic 115, demand forecasting logic (no extra period) 120, demand forecasting logic (extra past period) 125, and demand forecasting logic (extra future period) 130.

Method 200 is implemented to be performed by the RDF tool 110 of FIG. 1, or by a computing device configured with an algorithm of the method 200. Method 200 will be described from the perspective that a retail calendar has many retail periods (e.g., weeks) that are organized in a particular manner (e.g., four (4) thirteen (13) week quarters) over a typical calendar year. A retail period may occur in the past or in the future. In one embodiment, method 200 is implemented by a computer application to execute on a computing device, wherein the computer application is configured to process a retail calendar in electronic form.

Past retail periods are associated with historical demand data (e.g. actual sales data) of a historical time domain for an item sold from a particular retail location (e.g., a retail item carried by the organization). Future retail periods are associated with a forecast time domain (e.g., a next calendar year) for which future demand (e.g., predicted sales) is to be forecast for the item to be sold at the particular retail location. In some instances, one of the historical time domain or the forecast time domain may include an extra retail period (e.g., a 53^{rd} week). In other instances, neither the historical time domain nor the forecast time domain includes an extra retail period.

Upon initiating method 200, at block 210, historical demand data associated with a retail item sold at a retail location is read from at least one input data structure associated with a retail calendar computer application. In accordance with one embodiment, the historical demand data is read by the retail demand forecasting tool 110, implemented on the computing device 105, from the database device 145. Again, the historical demand data is associated with a historical time domain (e.g., one or two prior retail calendar years). In accordance with one embodiment, reading of the historical demand data may include parsing and/or analyzing the historical demand data.

At block 220, a determination is made as to whether or not an extra retail period occurs in the historical time domain (past) or the forecast time domain (future). In accordance with one embodiment, a data flag 147 (see FIG.

1) associated with an extra retail period alerts the RDF tool 110 to the presence of an extra retail period and to the location of the extra retail period in the historical time domain or the forecast time domain. In one embodiment, the source of the data flag 147 may be the retail calendar computer application, and information associated with the data flag 147 may originate, for example, in the database device 145.

At block 230, method 200 performs a branching decision based on the nature of any existing extra retail period. If no extra retail period exists in the historical time domain or the forecast time domain, method 200 proceeds to block 280. If an extra retail period exists in the historical time domain, method 200 proceeds to block 240. If an extra retail period exists in the forecast time domain, method 200 proceeds to block 260. Referring to FIG. 1, the switching logic 115 facilitates the branching decision of block 230, in accordance with one embodiment.

In the case where no extra retail period exists in either the historical demand data of the historical time domain or the forecast time domain, at block 280, forecasted demand data for the retail item is generated for the forecast time domain based on the read historical demand data. In the embodiment of FIG. 1, the DFL (no extra period) 120 generates the forecasted demand data as discussed previously herein. No special accounting for an extra retail period is employed.

In the case where an extra retail period exists in the historical demand data of the historical time domain, at block 240, the extra retail period is eliminated from the read historical demand data to form modified historical demand data. Furthermore, at block 250, forecasted demand data is generated over the forecast time domain for the retail item based on the modified historical demand data. In the embodiment of FIG. 1, the DFL (extra past period) 125 generates the forecasted demand data as discussed previously herein.

In the case where an extra retail period exists in the forecast time domain, at block 260, forecasted demand data is generated for the retail item for all retail periods in the forecast time domain, except for the extra retail period, based on the historical demand data. Furthermore, at block 270, forecasted demand data is generated for the extra retail period based on the forecasted demand data for at least a portion of the other retail periods in the forecast time domain. In the embodiment of FIG. 1, the DFL (extra future period) 130 generates the forecasted demand data as discussed previously herein.

In this manner, forecasted demand data may be generated, taking into account the presence or absence of an extra retail period (e.g., a 53^{rd} week) in the historical time domain or the forecast time domain. Seasonal peculiarities of a retail calendar are accounted for and seasonal comparisons from one retail calendar year to the next may be readily made. Method 200 may be repeated for a plurality of retail items sold at a plurality of retail locations. In this manner, forecasted demand data may be generated for multiple retail items across multiple retail locations quickly and efficiently, employing sophisticated forecasting techniques. For example, the computer algorithm may iteratively through an inventory database to read data records that identify each retail item carried/sold by the organization. Then for each retail item record (or for a selection of items), method 200 may be performed.

FIG. 3 illustrates one embodiment of a portion of method 200 of FIG. 2, performed by the retail demand forecasting tool 110 of the computer system 100 of FIG. 1. The portion of method 200 is associated with forecasting retail demand for an extra retail period in the future. In particular, FIG. 3 elaborates on block 270 of the method 200 of FIG. 2. Again, in the embodiment of FIG. 1, block 270 is performed by the DFL (extra future period) 130.

Referring to FIG. 3, at block 272, a demand populating technique is selected for the extra retail period occurring in the future (i.e., in the forecast time domain). In one embodiment, the demand populating technique is selected by a user of a retail calendar computer application, having the RDF tool 110, via the graphical user interface. In another embodiment, the RDF tool 110 makes the selection of the demand populating technique for the extra retail period.

For example, the DFL (extra future period) 130 of the RDF tool 110 may be configured to select an appropriate demand populating technique from a plurality of demand populating techniques. The appropriate demand populating technique may be that demand populating technique proven, based on history, to provide an accurate demand forecast for the extra retail period based on the particular situation. For example, in one embodiment, the DFL (extra future period) 130 may be configured to select an appropriate demand populating technique based on the location of the extra retail period in the forecast time domain.

At block 274, method 270 branches depending on whether the selected demand populating technique is a one-sided technique or a two-sided technique. A one-sided technique considers forecasted demand data to one side or the other of the extra retail period. A two-sided technique considers forecasted demand data on both sides of the extra retail period.

For example, at block 276, a one-sided technique is performed. The extra retail period is populated with forecasted demand data generated based on forecasted demand data for at least one retail period in the forecast time domain that occurs prior to the extra retail period. Similarly, at block 278, a one-sided technique is performed. The extra retail period is populated with forecasted demand data generated based on forecasted demand data for at least one retail period in the forecast time domain that occurs after the extra retail period. Finally, at block 279, a two-sided technique is performed. The extra retail period is populated with forecasted demand data generated based on forecasted demand data for at least one retail period in the forecast time domain that occurs prior to the extra retail period and at least one retail period in the forecast time domain that occurs after the extra retail period.

In this manner, forecasted demand data for an extra retail period occurring in the future (i.e., in a forecast time domain) may be generated for an item to be sold at a retail location. Forecasted demand data for retail periods in the forecast time domain occurring before and/or after the extra retail period may be analyzed to determine an accurate demand forecast for the extra retail period.

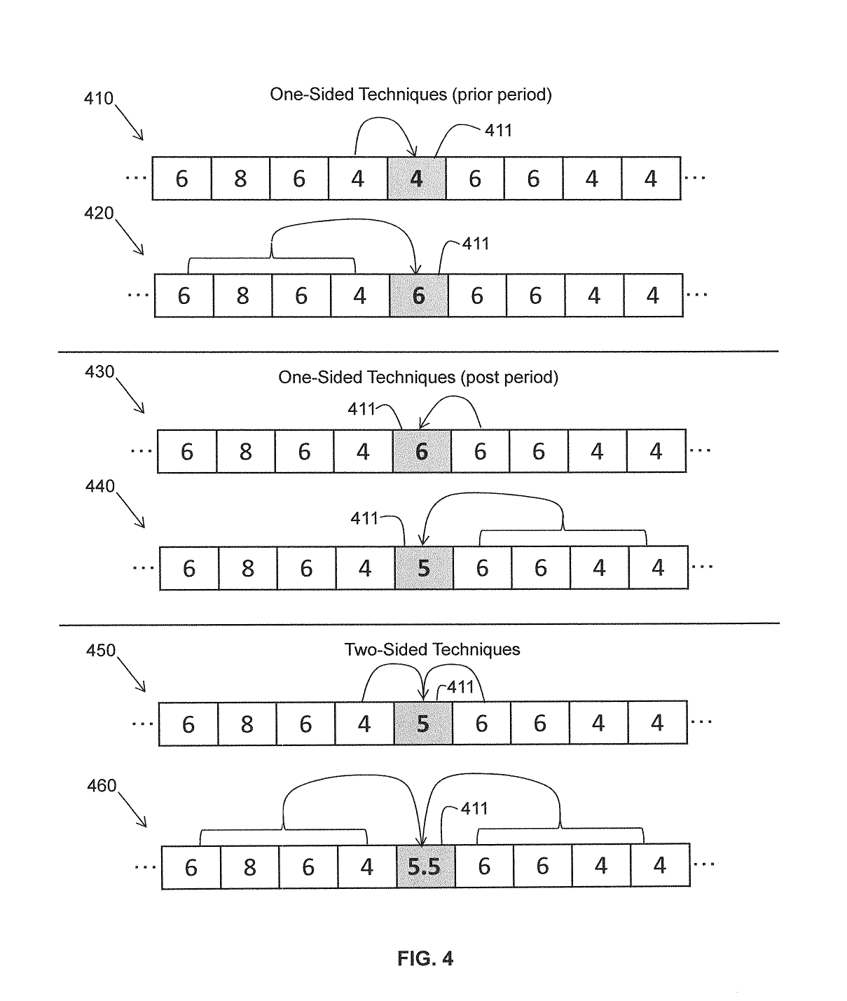

FIG. 4 illustrates first example embodiments of techniques for forecasting retail demand for an extra retail period in the future. The example embodiments shown in FIG. 4 may be performed by the retail demand forecasting tool 110 of the computer system 100 of FIG. 1, implementing block 270 of method 200 as shown in FIG. 3. In each of the example techniques (410-460) of FIG. 4, a portion of an output data structure is shown. The output data structure includes data fields or data cells representing contiguous future retail periods for a forecast time domain. The center cell 411 represents the extra retail period (e.g., a 53^{rd} week) in the forecast time domain which is to be populated with forecasted demand data.

As can be seen in FIG. 4, the retail periods on either side of the extra retail period 411 are populated with forecasted demand data, for example, at block 260 of method 200 of FIG. 2. Technique 410 is a one-sided technique for generating forecasted demand data for the extra retail period 411 based on forecasted demand data for a retail period occurring prior to the extra retail period 411.

One-sided technique 410 is a replication technique that simply replicates the value (4) of the demand data for the retail period immediately prior to the extra retail period 411 and populates the extra retail period 411 with that demand value (4). The value (4) represents the forecasted number (demand) of an item predicted to be sold in the retail period at a particular location (store). Such a replication technique may be appropriate when history indicates that the retail period immediately prior to an extra retail period at a particular location in a retail year is indicative of what the demand will be for that extra retail period.

If the extra retail period is the first retail period of the forecast time domain, then the value for the second retail period may be replicated for the extra retail period, in accordance with one embodiment. Similarly, if the extra retail period is the last retail period of the forecast time domain, then the value for the second to last retail period may be replicated for the extra retail period, in accordance with one embodiment.

One-sided technique 420 is an averaging technique that transforms, by averaging, the values (6, 8, 6, 4) of the demand data for the four (4) retail periods immediately prior to the extra retail period 411 and populates the extra retail period 411 with the average value (6). Such an averaging technique may be appropriate when history indicates that several retail periods immediately prior to an extra retail period at a particular location in a retail year are indicative of what the demand will be for that extra retail period.

One-sided techniques 430 and 440 are similar to one-sided techniques 410 and 420, respectively. However, one-sided techniques 430 and 440 consider forecasted demand data in retail periods occurring after the extra retail period 411. Since the demand data values in the retail periods occurring after the extra retail period are different than the demand data values occurring prior to the extra retail period, the resultant forecasted demand data for the extra retail period is likely to be different. (e.g., values of 6 and 5 instead of 4 and 6). Such one-sided techniques may be appropriate when history indicates that one or more retail periods occurring after an extra retail period at a particular location(s) in a retail year are indicative of what the demand will be for that extra retail period.

Two-sided techniques 450 and 460 take into consideration forecasted demand data on both sides of the extra retail period 411. Two-sided technique 450 transforms, by averaging, the forecasted demand data (4 and 6) in the retail periods immediately prior to and immediately after the extra retail period 411 to determine the forecast demand value (5) for the extra retail period 411. Two-sided technique 460 transforms, by averaging, several (e.g. four) retail periods on both sides of the extra retail period 411 to determine the forecast demand value (5.5) for the extra retail period 411. Such two-sided techniques may be appropriate when history indicates that two or more retail periods occurring before and after an extra retail period at particular locations in a retail year are indicative of what the demand will be for that extra retail period.

In this manner, in accordance with the embodiment of FIG. 1, the DFL (extra future period) 130 is configured to determine which demand populating technique is appropriate for a particular extra retail period in a forecast time domain. In slightly different embodiments, the techniques 410-460 generate demand values for the extra retail periods in a similar manner, but assign the demand values to the extra retail periods. In such different embodiments, a pointer data structure may include pointers that link forecast demand values to retail periods as a result of the assignments.

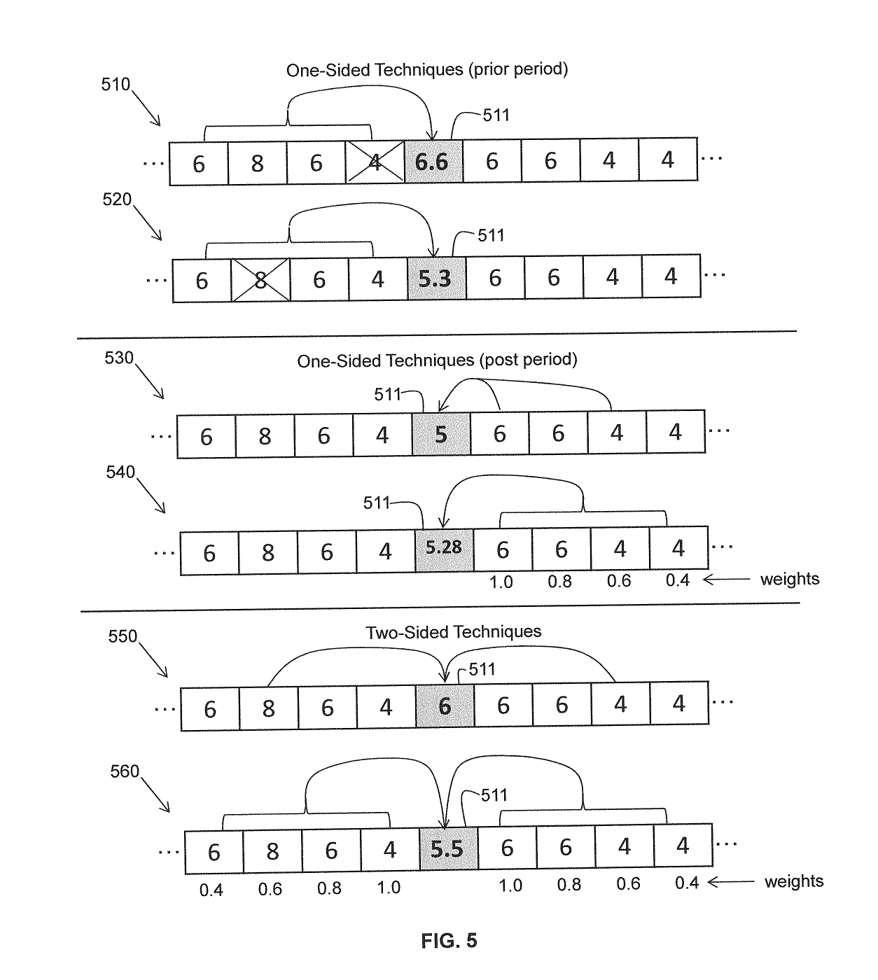

FIG. 5 illustrates second example embodiments of forecasting retail demand for an extra retail period 511 in the future. The example embodiments shown in FIG. 5 may be performed by the retail demand forecasting tool 110 of the computer system 100 of FIG. 1, implementing block 270 of method 200 as shown in FIG. 3.

In each of the example techniques (510-560) of FIG. 5, a portion of an output data structure is shown. The output data structure includes data cells or data fields representing contiguous future retail periods for a forecast time domain. The center cell 511 represents the extra retail period (e.g., a 53^{rd} week) in the forecast time domain which is to be populated with forecasted demand data.

As can be seen in FIG. 5, the retail periods on either side of the extra retail period 511 are populated with forecasted demand data, for example, at block 260 of method 200 of FIG. 2. Technique 510 is a one-sided technique for generating forecasted demand data for the extra retail period 511 based on forecasted demand data for retail periods occurring prior to the extra retail period 511.

One-sided technique 510 is a partial averaging technique that transforms, by averaging, the forecast demand values (6, 8, 6, 4), except for the smallest value (4), from the four (4) retail periods immediately prior to the extra retail period 511. The extra retail period 511 is populated with the resultant average value (6.6). Such a partial averaging technique may be appropriate when history indicates that the largest demand forecast values, from several retail periods immediately prior to an extra retail period at a particular location in a retail year, are indicative of what the demand will be for that extra retail period.

One-sided technique 520 is a partial averaging technique that averages the forecast demand values (6, 8, 6, 4), except for the largest value (8), from the four (4) retail periods immediately prior to the extra retail period 511. The extra retail period 511 is populated with the resultant average value (5.3). Such a partial averaging technique may be appropriate when history indicates that the smallest demand forecast values, from several retail periods immediately prior to an extra retail period at a particular location in a retail year, are indicative of what the demand will be for that extra retail period.

One-sided technique 530 is a partial averaging technique that averages the forecast demand values (6, 6, 4, 4), except for one largest value (6) and one smallest value (4), from the four (4) retail periods immediately after the extra retail period 511. The extra retail period 511 is populated with the resultant average value (5). Such a partial averaging technique may be appropriate when history indicates that intermediate demand forecast values, from several retail periods immediately after an extra retail period at a particular location in a retail year, are indicative of what the demand will be for that extra retail period.

One-sided technique 540 is a weighted averaging technique that generates a weighted average of the forecast demand values (6, 6, 4, 4) from the four (4) retail periods immediately after the extra retail period 511. The extra retail period 511 is populated with the resultant average value (5.28). Such a weighted averaging technique may be appropriate when history indicates that, the closer a retail period is to the extra retail period, the more indicative that retail period is of what the demand will be for the extra retail period. As seen for the one-sided technique 540 in FIG. 5, the weights (1.0, 0.8, 0.6, and 0.4) become smaller for retail periods further away from the extra retail period 511.

The two-sided technique 550 is an averaging technique that averages a maximum demand value (8) with a minimum demand value (4). The maximum demand value (8) is from the set of the four (4) demand values (6, 8, 6, 4) of the four (4) retail periods immediately prior to the extra retail period 511. The minimum demand value (4) is from the set of the four (4) demand values (6, 6, 4, 4) of the four (4) retail periods immediately following the extra retail period 511. Such an averaging technique may be appropriate when history indicates that maximum and minimum demand values from retail periods before and after an extra retail period, at a particular location in a retail year, are indicative of what the demand will be for that extra retail period.

The two-sided technique 560 is a weighted averaging technique similar to the one-sided weighted averaging technique 540. However, the two-sided technique 560 takes into consideration forecast demand values for retail periods on both sides of the extra retail period 511. Such a weighted averaging technique may be appropriate when history indicates that, the closer a retail period is to the extra retail period, the more indicative that retail period is of what the demand will be for the extra retail period. Again, the weights (1.0, 0.8, 0.6, and 0.4) become smaller for retail periods further away from the extra retail period 511.

In slightly different embodiments, the techniques 510-560 generate demand values for the extra retail periods in a similar manner, but assign the demand values to the extra retail periods. In such different embodiments, a pointer data structure may include pointers that link forecast demand values to retail periods as a result of the assignments. In accordance with other embodiments, other techniques of forecasting retail demand for an extra retail period in a forecast time domain are possible as well, without departing from the scope of the present application. The techniques discussed above herein illustrate a small subset of the possible embodiments.

In this manner, in accordance with the embodiment of FIG. 1, the DFL (extra future period) 130 is configured to determine which demand populating technique is appropriate for a particular extra retail period in a forecast time domain for an item. Furthermore, the DFL (extra future period) 130 may be configured to readily provide a plurality of sophisticated demand populating techniques which can generate accurate demand solutions for a plurality of different items to be sold across a plurality of different retail locations.

Systems, methods, and other embodiments for providing management of retail forecasts associated with a computer application have been described herein. In one embodiment, a retail demand forecasting tool is configured to read historical demand data associated with a retail item sold at a retail location from an input data structure. The tool is configured to make a determination as to when and where an extra retail period occurs in a forecast time domain. The tool is also configured to generate forecasted demand data for retail periods of the forecast time domain, except the extra retail period, based on the historical demand data. Furthermore, the tool is configured to generate forecasted demand data for the extra retail period based on the forecasted demand data for a portion of the other retail periods of the forecast time domain. An output data structure is transformed by the tool by populating the output data structure with the forecasted demand data for the retail periods, including the extra retail period, of the forecast time domain.

### Computing Device Embodiment

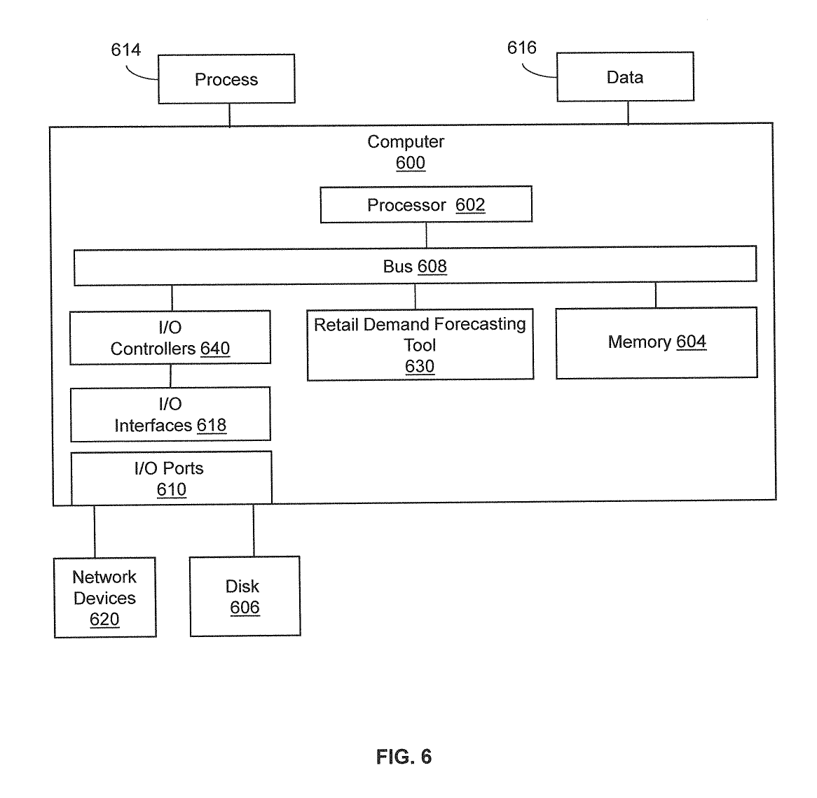

FIG. 6 illustrates an example computing device that is configured and/or programmed with one or more of the example systems and methods described herein, and/or equivalents. FIG. 6 illustrates one example embodiment of a computing device upon which an embodiment of a retail demand forecasting (RDF) tool may be implemented. The example computing device may be a computer 600 that includes a processor 602, a memory 604, and input/output ports 610 operably connected by a bus 608. In one example, the computer 600 may include RDF tool 630 configured to facilitate the forecasting of retail demand while accounting for any extra 53^{rd} week in a retail calendar year. In different examples, the tool 630 may be implemented in hardware, a non-transitory computer-readable medium with stored instructions, firmware, and/or combinations thereof. While the tool 630 is illustrated as a hardware component attached to the bus 608, it is to be appreciated that in other embodiments, the tool 630 could be implemented in the processor 602, stored in memory 604, or stored in disk 606.

In one embodiment, tool 630 or the computer 600 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the forecasting of retail demand for a retailer. The means may also be implemented as stored computer executable instructions that are presented to computer 600 as data 616 that are temporarily stored in memory 604 and then executed by processor 602.

Tool 630 may also provide means (e.g., hardware, non-transitory computer-readable medium that stores executable instructions, firmware) for facilitating the forecasting of retail demand for a retailer.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM, PROM, and so on. Volatile memory may include, for example, RAM, SRAM, DRAM, and so on.

A storage disk 606 may be operably connected to the computer 600 via, for example, an input/output interface (e.g., card, device) 618 and an input/output port 610. The disk 606 may be, for example, a magnetic disk drive, a solid state disk drive, a floppy disk drive, a tape drive, a Zip drive, a flash memory card, a memory stick, and so on. Furthermore, the disk 606 may be a CD-ROM drive, a CD-R drive, a CD-RW drive, a DVD ROM, and so on. The memory 604 can store a process 614 and/or a data 616, for example. The disk 606 and/or the memory 604 can store an operating system that controls and allocates resources of the computer 600.

The computer 600 may interact with input/output devices via the i/o interfaces 618 and the input/output ports 610. Input/output devices may be, for example, a keyboard, a microphone, a pointing and selection device, cameras, video cards, displays, the disk 606, the network devices 620, and so on. The input/output ports 610 may include, for example, serial ports, parallel ports, and USB ports.

The computer 600 can operate in a network environment and thus may be connected to the network devices 620 via the i/o interfaces 618, and/or the i/o ports 610. Through the network devices 620, the computer 600 may interact with a network. Through the network, the computer 600 may be logically connected to remote computers. Networks with which the computer 600 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C, §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. §101.

“Logic”, as used herein, represents a component that is implemented with computer or electrical hardware, firmware, a non-transitory medium with stored instructions of an executable application or program module, and/or combinations of these to perform any of the functions or actions as disclosed herein, and/or to cause a function or action from another logic, method, and/or system to be performed as disclosed herein. Logic may include a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. Logic is limited to statutory subject matter under 35 U.S.C. §101.

“User”, as used herein, includes but is not limited to one or more persons, computers or other devices, or combinations of these.

“Operable interaction”, as used herein, refers to the logical or communicative cooperation between two or more logics via an operable connection to accomplish a function.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A method implemented by a computer application configured to execute on a computing device, wherein the computer application is configured to process a retail calendar in electronic form, the method comprising:
for a retail item carried by a retail location:
reading, from at least one input data structure, historical demand data representing sales data for the retail item sold at the retail location;
determining a forecast time domain that includes a plurality of future retail periods in the retail calendar;
determining when and where an extra retail period occurs in the forecast time domain; and
in response to the extra retail period being determined to occur in the forecast time domain:
(i) generating a first forecasted demand data for the retail item that predicts sales of the retail item based on the historical demand data, wherein the first forecasted demand data is generated for the plurality of future retail periods excluding the extra retail period,
(ii) generating a second forecasted demand data for the retail item that predicts sales of the retail item for the extra retail period based on at least a portion of the first forecasted demand data, and
(iii) transforming an output data structure, by the computer application, to form a set of final forecast data by populating the output data structure with the first forecasted demand data for the plurality of future retail periods, and including the second forecasted demand data for the extra retail period.

2. The method of claim 1, further comprising:
determining when and where the extra retail period occurs in the historical demand data; and
when the extra retail period is determined to occur in the historical demand data:
(i) transforming the input data structure by eliminating a portion of the historical demand data corresponding to the extra retail period to form modified historical demand data within the input data structure,
(ii) generating third forecasted demand data for the retail item that predicts sales of the retail item based on the modified historical demand data, wherein the third forecasted demand data is generated for the plurality of future retail periods, and
(iii) transforming the output data structure, by the computer application, to form the set of final forecast data by populating the output data structure with the third forecasted demand data for the plurality of future retail periods.

3. The method of claim 2, further comprising repeating the method for a plurality of retail items sold at a plurality of retail locations.

4. The method of claim 2, further comprising reading a data flag associated with the extra retail period, wherein determining when and where the extra retail period occurs in the forecast time domain or in the historical demand data is based on the data flag.

5. The method of claim 1, wherein generating the second forecasted demand data for the extra retail period comprises:
replicating the first forecasted demand data for the retail period immediately prior to the extra retail period forming replicated demand data; and
assigning the replicated demand data to the extra retail period.

6. The method of claim 1, wherein generating the second forecasted demand data for the extra retail period comprises:
replicating the first forecasted demand data for the retail period immediately following the extra retail period forming replicated demand data; and
assigning the replicated demand data to the extra retail period.

7. The method of claim 1, wherein generating the second forecasted demand data for the extra retail period comprises:
averaging at least a portion of the first forecasted demand data, for the future retail periods of the forecast time domain, forming averaged demand data; and
assigning the averaged demand data to the extra retail period.

8. The method of claim 7, wherein the averaged demand data comprises a weighted average.

9. The method of claim 1, wherein the extra retail period comprises a 53^{rd} week in a retail calendar year.

10. A computing system, comprising:
visual user interface logic configured to facilitate:
(i) inputting flag data into a first input data structure associated with a retail calendar computer application, wherein the flag data indicates when and where an extra retail period occurs in a historical time domain or a forecast time domain associated with a retail item, and
(ii) inputting historical demand data, associated with the retail item sold at a retail location during the historical time domain, into a second input data structure associated with the retail calendar computer application;
demand forecasting logic, configured to generate forecasted demand data that predicts retail sales for the retail item over the forecast time domain, wherein the demand forecasting logic includes:
(i) a first forecasting module configured to generate the forecasted demand data when the extra retail period does not occur in the historical time domain or in the forecast time domain,
(ii) a second forecasting module configured to generate the forecasted demand data when the extra retail period occurs in the historical time domain, and
(iii) a third forecasting module configured to generate the forecasted demand data when the extra retail period occurs in the forecast time domain; and
switching logic configured to trigger one of the first forecasting module, the second forecasting module, or the third forecasting module of the demand forecasting logic in response to the flag data.

11. The computing system of claim 10, wherein the second forecasting module of the demand forecasting logic is configured to:
transform the second input data structure by eliminating a portion of the historical demand data corresponding to the extra retail period to form modified historical demand data within the second input data structure; and
generate the forecasted demand data, for the retail item at the retail location over the forecast time domain, based on the modified historical demand data.

12. The computing system of claim 10, wherein the third forecasting module of the demand forecasting logic is configured to:
generate a first portion of the forecasted demand data, for the retail item at the retail location, over retail periods of the forecast time domain except the extra retail period based on the historical demand data; and
generate a second portion of the forecasted demand data, for the retail item at the retail location, for the extra retail period based on at least a part of the first portion of the forecasted demand data.

13. The computing system of claim 10, further comprising a display screen configured to display and facilitate user interaction with at least a graphical user interface associated with the retail calendar computer application, wherein the visual user interface logic is configured to generate the graphical user interface.

14. The computing system of claim 13, wherein the demand forecasting logic is configured to transform an output data structure, associated with the retail calendar computer application, by populating the output data structure with the forecasted demand data for the forecast time domain to form a set of final forecast data.

15. The computing system of claim 14, wherein the demand forecasting logic is configured to operably interact with the visual user interface logic to facilitate displaying of the set of final forecast data of the output data structure, via the graphical user interface, on the display screen.

16. The computing system of claim 10, further comprising a database device configured to store data structures associated with the retail calendar computer application.

17. A non-transitory computer-readable medium storing computer-executable instructions that are part of an algorithm that, when executed by a computer, cause the computer to perform a method, wherein the instructions comprise instructions configured for:
reading historical demand data, representing sales data associated with a retail item sold at a retail location, from at least one input data structure associated with a retail calendar computer application;
selecting a demand populating technique, from a plurality of demand populating techniques, for populating an extra retail period in a forecast time domain comprising a plurality of future retail periods with extra forecasted demand data, wherein the plurality of demand populating techniques include:
(i) one-sided techniques configured to consider forecasted demand data for future retail periods occurring either before the extra retail period or after the extra retail period, and
(ii) two-sided techniques configured to consider forecasted demand data for future retail periods occurring both before and after the extra retail period; and
generating the extra forecasted demand data for the extra retail period based on the historical demand data and the selected demand populating technique.

18. The non-transitory computer-readable medium of claim 17, wherein the instructions for generating the extra forecasted demand data for the extra retail period, based on the one-sided techniques, include instructions for transforming the forecasted demand data from one of:
(i) at least a portion of the future retail periods occurring prior to the extra retail period, or
(ii) at least a portion of the future retail periods occurring after the extra retail period,
wherein (i) or (ii) is transformed to the extra forecasted demand data for the extra retail period.

19. The non-transitory computer-readable medium of claim 17, wherein the instructions for generating the extra forecasted demand data for the extra retail period, based on the two-sided techniques, include instructions configured for transforming the forecasted demand data from:
(i) at least a portion of the future retail periods occurring prior to the extra retail period, and
(ii) at least a portion of the future retail periods occurring after the extra retail period, wherein (i) and (ii) is transformed to the extra forecasted demand data for the extra retail period.

20. The non-transitory computer-readable medium of claim 17, wherein the instructions for generating the extra forecasted demand data for the extra retail period, based on the selected demand populating technique, include instructions configured for performing at least one of:
replicating the forecasted demand data from at least a portion of the future retail periods in the forecast time domain;
averaging the forecasted demand data from at least a portion of the future retail periods in the forecast time domain;
weighting the forecasted demand data from at least a portion of the future retail periods in the forecast time domain;
selecting a maximum value of the forecasted demand data from at least a portion of the future retail periods in the forecast time domain; and
selecting a minimum value of the forecasted demand data from at least a portion of the future retail periods in the forecast time domain.
